(19) United States
(12) Patent Application Publication
(10) Pub. No.: US 2025/0263315 A1
(43) Pub. Date: Aug. 21, 2025

(54) METHOD FOR TREATMENT OF WASTEWATER WITH HIGH BORON CONCENTRATION

(71) Applicant: GEBZE TEKNIK UNIVERSITESI, Kocaeli (TR)

(72) Inventors: Bulent KESKINLER, Kocaeli (TR); Ahmet KARAGUNDUZ, Kocaeli (TR); Zehra Betul OCAL, Kocaeli (TR); Mehmet Salim ONCEL, Kocaeli (TR)

(73) Assignee: GEBZE TEKNIK UNIVERSITESI, Kocaeli (TR)

(21) Appl. No.: 18/856,650

(22) PCT Filed: Apr. 11, 2023
(86) PCT No.: PCT/TR2023/050338

§ 371 Date: Oct. 14, 2024

(30) Foreign Application Priority Data
Apr. 12, 2022 (TR) 2022/005858

(51) Int. Cl. C02F 1/52; C02F 1/66; C02F 101/10

(52) U.S. Cl. CPC C02F 1/5236; C02F 1/66; C02F 2101/108; C02F 2301/08

(57) ABSTRACT

A method for the treatment of wastewater from the boron industry with high boron concentrations, using an aluminum hydroxide adsorbent that enables sustainable, economical, recovery, is provided. The facilities used in the method include neutralization pond, 1st decanter, Ca(OH)₂ treatment fast stirring reactor, Ca(OH)₂ tank, Ca(OH)₂ treatment slow stirring reactor, 2nd decanter, Al(OH)₃ treatment fast stirring reactor, Al(OH)₃ tank, Al(OH)₃ treatment slow stirring reactor, 3rd decanter, H₂SO₄ tank, desorption tank, and 2nd H₂SO₄ tank.

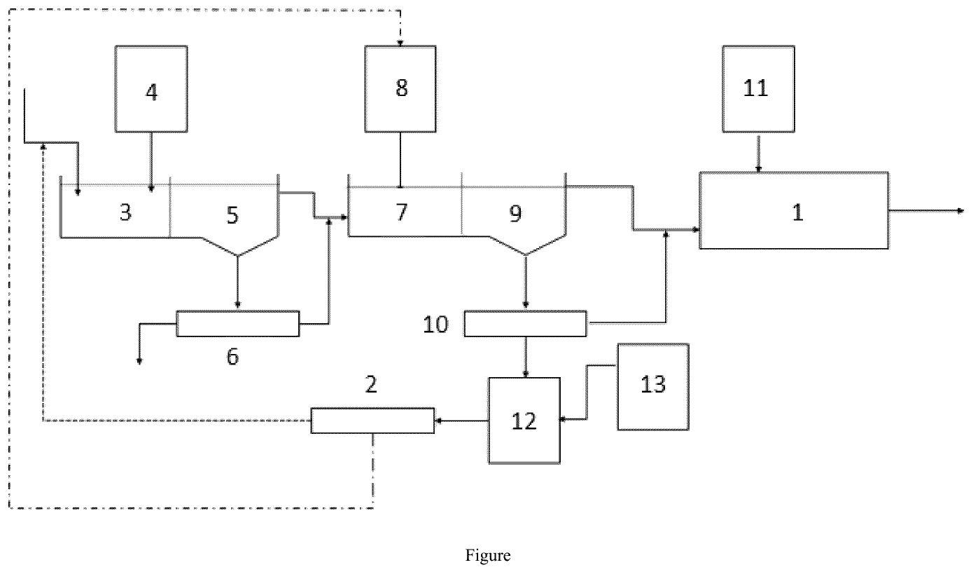

### CROSS REFERENCE TO THE RELATED APPLICATIONS

This application is the national phase entry of International Application No. PCT/TR2023/050338, filed on Apr. 11, 2023, which is based upon and claims priority to Turkish Patent Application No. 2022/005858, filed on Apr. 12, 2022, the entire contents of which are incorporated herein by reference.

### TECHNICAL FIELD

The invention relates to a method for the treatment of wastewater from the boron industry and with high boron concentrations, using an aluminum hydroxide adsorbent that enables sustainable, economical, recovery.

### BACKGROUND

Boron removal methods vary according to boron concentration. Generally, one of the most effective methods used for wastewater or irrigation water with low boron concentrations (<1000 mg/L) is the ion exchange method using ion exchange resins [1]. However, these methods are generally used to control boron concentration in irrigation water and drinking water systems. Boron is removed from water by complexation reactions with polymeric resins. Another common method for wastewater with low boron concentration is membrane processes. In membrane processes, the pH value affects the boron rejection performance. Increasing the pH value from neutral to 9.2, the pKa value of boric acid, increases the boron removal efficiency. At high pH, boron ions are transformed into larger molecular sized boron forms and are prevented from passing through the membrane surface. When the pH is further increased, calcium borate and magnesium hydroxide coatings block the membrane and filtration efficiency decreases [2].

There is no economical and sustainable method for wastewater with high boron concentrations. It is known that chemical coagulation processes with lime, alumina, FeCl₃ are not sufficient alone and do not allow recovery and reuse [3]. According to the results of laboratory studies, in cases where lime is used, the pH value can be increased to 11.5 and the boric acid concentration can be reduced from 25000-80000 ppm to 2000-2500 ppm. However, a high amount of sludge formation is observed and discharge standards cannot be met. Adsorbents such as natural clay minerals and activated carbon do not show efficient effects at high boron concentrations. Low concentrations of magnesium oxide (MgO) [4], cerium oxide [5], activated carbon [6], activated alumina [7], activated carbon impregnated with salicylic acid [8], iron-rich natural clays [9], activated sludge [10], neutralized red mud and composite magnetic particles are effective in boron removal and allow reuse, but the cost of use is high because they need to be activated by heating. Systems such as evaporation, crystallization and solvent extraction are used for boric acid purification rather than boron removal due to their high costs. Even when heat treatment is used, the concentration can be reduced up to 1000 ppm and even in this case, it is seen that it is difficult to meet the discharge standards. For this reason, it is necessary to develop new sustainable treatment methods to obtain effluent to discharge standards in conventional boron treatment processes.

In the known state of the art Japanese patent document numbered JP2007301456A, the method of separation of boron compounds in wastewater by solid-liquid phase separation by forming insoluble precipitates in basic medium is mentioned. By adding slaked lime (aluminum sulfate and calcium compound), the pH value of wastewater is increased to 9 and above.

In the known state of the art Japanese patent document numbered JP2002346574A, it is mentioned that it contains a neutralization tank using aluminum and calcium-based compounds, to lower the pH range to the basic environment, separation by solid-liquid phase separation, and neutralization tank using acid.

In the known state of the art, Japanese patent document JP2010172853A, it is mentioned an adsorbent used to retain boron compounds and a membrane that performs this process.

The feature of the Al(OH)₃ compound in the developed method, which allows the reuse of it as an adsorbent by adjusting the pH values, is not included in the known state of the art. By reusing Al(OH)₃ adsorbent, waste chemical disposal to the environment is reduced and economic advantage is provided. Therefore, there is a need to develop a new method for the treatment of wastewater with high boron concentration, which allows the reuse of Al(OH)₃ compound as adsorbent by adjusting the pH values.

### SUMMARY

The purpose of the present invention is to realize the method developed using aluminum hydroxide adsorbent for the treatment of wastewater containing high concentrations of boron under sustainable conditions.

Another purpose of the present invention is to realize the method developed using aluminum hydroxide adsorbent to reduce the boron concentration of wastewater with high boron concentration below the discharge limits.

### BRIEF DESCRIPTION OF THE DRAWINGS

A method for achieving the purposes of the present invention using an aluminum hydroxide adsorbent is shown in the attached FIGURE.

This FIGURE;

FIGURE: Schematic view of the method in which Al(OH)₃ is used in adsorption and desorption processes.

The parts in the FIGURE are numbered one by one and the equivalents of these numbers are given below.
1. Neutralization pond
2. 1st decanter
3. Ca(OH)₂ treatment fast stirring reactor
4. Ca(OH)₂ tank
5. Ca(OH)₂ treatment slow stirring reactor
6. 2nd decanter
7. Al(OH)₃ treatment fast stirring reactor
8. Al(OH)₃ tank
9. Al(OH)₃ treatment slow stirring reactor
10. 3rd decanter
11. H₂SO₄ tank
12. Desorption tank
13. 2nd H₂SO₄ tank

### DETAILED DESCRIPTION OF THE EMBODIMENTS

The Invention is a method for the treatment of wastewater with high boron concentrations and comprises the following process steps;
mixing the wastewater from the neutralization pond (1) and the wastewater from the 1st decanter (2) and sending it to the (Ca(OH)₂) chemical treatment fast stirring reactor (3) where precipitation will be carried out by increasing the pH value to 11-11.5 by means of calcium hydroxide (Ca(OH)₂), which is a basic chemical substance used as a 10% solution or in powder form,
increasing the pH value of the wastewater to the range of 11-11.5 with 10% (Ca(OH)₂) solution from the (Ca(OH)₂) tank (4),
transmitting the mixture of wastewater and Ca(OH)₂ to the Ca(OH)₂ chemical treatment slow stirring reactor (5),
transmitting the sludge from the Ca(OH)₂ chemical treatment slow stirring reactor (5) for solid liquid phase separation to the 2nd decanter (6) and dewatering there
sending the sludge from the 2nd decanter (6) to the storage area for storage,
sending the water from the 2nd decanter (6) and the clear phase from the Ca(OH)₂ treatment slow stirring reactor (5) to the Al(OH)₃ treatment fast stirring reactor (7) in the second chemical treatment process,
fresh preparation of Al(OH)₃ compound and storage in Al(OH)₃ tank (8) by using Al₂(SO₄)₃·18H₂O solution in the production of the adsorbent (Al(OH)₃) to be used in order to provide effective adsorption and NaOH solution to bring the adsorption agent to the active form,
performing the stirring process with Al(OH)₃ of the mixtures coming to the Al(OH)₃ treatment fast stirring reactor (7) and then continuing the stirring process in the Al(OH)₃ treatment slow stirring reactor (9),
transmitting and dewatering the sludge from the Al(OH)₃ treatment slow stirring reactor (9) to the 3rd decanter (10),
sending the clear phase from the Al(OH)₃ treatment slow stirring reactor (9) and the water phase from the 3rd decanter (10) to the neutralization pond (1),
sending the treated water to the pH value neutralization pond (1) before discharge,
reducing below the discharge standard value using sulfuric acid (H₂SO₄) solution stored in H₂SO₄ tank (11),
transmitting the solids from the 3rd decanter (10) to the desorption reactor (12),
exposing the solid to desorption process in an acidic environment using H₂SO₄ solution, which is an acidic chemical substance that creates desorption conditions and removes boron compounds from the surface of the adsorbent in order to enable the reuse of the adsorbent in the desorption reactor (12),
sending the sludge from the desorption tank (12) to the 1st decanter (2),
sending sludge from the 1st decanter (2), preferably after washing with effluent, to the Al(OH)₃ tank (8) for reuse as it contains Al(OH)₃,
sending the water with high boron content from the 1st decanter (2) to the head of the plant

The developed method performs gradual treatment. This method, which is designed to perform an economical treatment of wastewater with a boron concentration of 3000 mg/L and above, has 2 stages. In the first stage, the wastewater from the neutralization pond (1) and the wastewater from the recycle stream of the 1st decanter (2) are mixed and sent directly to the Ca(OH)₂ treatment fast stirring reactor (3) where precipitation with lime will be carried out. At this stage, the pH value of the wastewater is in the range of 7.8-8.5. In the Ca(OH)₂ treatment fast stirring reactor (3), the pH value of the water is raised to 11-11.5 with 10% lime solution supplied from the Ca(OH)₂ tank (4). Then it is taken to the Ca(OH)₂ treatment slow stirring reactor (5) and mixed. The sludge is transported to the 2nd decanter (6) for solid liquid phase separation and dewatered through the 2nd decanter (6). The sludge containing approximately 25% solids is sent to the storage area for storage. The water from the 2nd decanter (6) is combined with the clear phase from the Ca(OH)₂ treatment slow stirring reactor (5) and sent to the second chemical treatment process. According to the initial pH value of the wastewater; while negatively charged boron polymers are precipitated in the pH 8.5-9.0 band, boron precipitates in the form of calcium borate at higher pH values. After pre-precipitation, the boron concentration in the water is reduced to the range of 900-1000 mg/L. These values are equivalent to the solubility of calcium borate in water.

The second stage of boron removal is boron removal with Al(OH)₃. The Al(OH)₃ used must be freshly prepared using Al₂(SO₄)₃·18H₂O. For the preparation of Al(OH)₃, Al₂(SO₄)₃·18H₂O solution is prepared and the pH value is increased to 5.5-6.0 using NaOH solution. At this pH value, Al(OH)₃ solubility is minimum. The resulting solution is filtered to increase the solid Al(OH)₃ concentration and stored in the Al(OH)₃ tank (8). The pretreated wastewater is dosed with Al(OH)₃ in the treatment fast stirring reactor (7). The stirring process is continued in the Al(OH)₃ treatment slow stirring reactor (9). In this process, the pH value should be kept in the range of 10.2-10.5. At the end of the reaction period, the boron concentration in the wastewater can be reduced below 500 mg/L depending on the dosage amount. The sludge taken from the Al(OH)₃ treatment slow stirring reactor (9) is transferred to the 3rd decanter (10). With the help of the 3rd decanter (10), the sludge is dewatered to a solid content of approximately 12% and taken to the desorption tank (12). Here, the stored H₂SO₄ solution is dosed with the 2nd H₂SO₄ tank (13) until the pH value of the sludge is reduced to 4.0-4.5 and desorption is achieved. The reaction time in the desorption tank (12) should be at least one hour. The sludge is then transported to the 1st decanter (2) where the solids content is increased to 25%. Here, the water from the 1st decanter (2) with high boron content is sent to the head of the plant. The solid sludge from the 1st decanter (preferably after washing with effluent) is returned to the Al(OH)₃ tank (8) for reuse. Thus, the used Al(OH)₃ is continuously circulated in the process. Before the treated water is discharged, the pH value is sent to the neutralization pond (1). It should be reduced below the discharge standard of 9 by using H₂SO₄ solution stored in the H₂SO₄ tank (11).

In laboratory scale studies, 15 g/L Ca(OH)₂ was added to the wastewater containing 4700 mg/L boron and the pH value was increased to 11. It was stirred for 2 hours and at the end of the stirring time, the lime was allowed to settle. The liquid phase of the sample, whose solid and liquid phases were clearly separated, was filtered to remove all particles. At this stage, the boron content of the sample was reduced to 1090 mg/L. It was prepared using Al₂(SO₄)₃·18H₂O and dried at room temperature. 20 g/L Al(OH)₃ was added and stirred for 2 hours and filtered to allow precipitation at the end of the time. When the liquid phase was measured, it was observed that the boron concentration decreased to 243 mg/L. The pH value of the solution obtained by adding distilled water to the remaining Al(OH)₃ precipitate was reduced to 5.5 using H₂SO₄ solution, stirred for 1 hour and filtered at the end of the time and the boron concentration in the liquid phase was measured as 527 mg/L. When Al(OH)₃ desorbed at pH value of 5.5 was added to the pretreated wastewater containing 1090 mg/L boron and adsorption study was performed again, it was observed that the boron concentration was 349 mg/L as a result of adsorption, while the boron concentration in the liquid phase obtained as a result of Al(OH)₃ desorption was 516 mg/L. The sequential adsorption and desorption study was repeated 5 times and it was observed that the performance loss of Al(OH)₃ was approximately 10% after 5 times of use.

The study was also tested in a pilot plant. The pH value of the wastewater with a boron concentration of 3600 mg/L was increased above 10.5 using a 10% lime Ca(OH)₂ solution and 0.1% anionic polyelectrolyte solution was added to facilitate precipitation and stirred for 1 hour. The boron content of the resulting liquid phase was measured as 920 mg/L. The pretreated wastewater was dosed with 14 kg/m³ Al(OH)₃ solution prepared in the pilot plant using Al₂(SO₄)₃·18H₂O and stirred for 1 hour. The mixture was filtered using a filterpress and the boron concentration in the liquid phase was measured as 431 mg/L. The aqueous solution of solid Al(OH)₃ was prepared, the pH value was reduced to 5.5 using H₂SO₄ solution and stirred for 1 hour and at the end of the time, the solid Al(OH)₃ and the liquid phase were separated using a filterpress and the boron concentration of the liquid phase was measured as 1029 mg/L. The solid Al(OH)₃ was reused in the process.

The advantages obtained with the developed method are listed below.
By connecting Al(OH)₃ adsorption and desorption units to conventional (lime) treatment processes, boron removal efficiency has been increased.
The boron adsorbed by the pH adjustment of the Al(OH)₃ used was added to the head of the lime unit by desorption, allowing the recovery and reuse of Al(OH)₃, which can be used for adsorption again after desorption.

What is claimed is:

1. A method for a treatment of wastewater with high boron concentrations, comprising process steps of:
mixing the wastewater from a neutralization pond and the wastewater from a 1st decanter and sending a mixed wastewater to a Ca(OH)₂ chemical treatment fast stirring reactor, wherein a precipitation is carried out by increasing a pH value of the mixed wastewater to 11-11.5 by means of calcium hydroxide (Ca(OH)₂), the Ca(OH)₂ is a basic chemical substance used as a 10% solution or in a powder form,
increasing the pH value of the mixed wastewater to a range of 11-11.5 with a 10% Ca(OH)₂ solution from a Ca(OH)₂ tank to obtain a first mixture,
transmitting the first mixture to a Ca(OH)₂ chemical treatment slow stirring reactor to obtain a first sludge,
transmitting the first sludge from the Ca(OH)₂ chemical treatment slow stirring reactor to a 2nd decanter for a solid liquid phase separation and dewatering in the 2nd decanter to obtain a second sludge,
sending the second sludge from the 2nd decanter to a storage area for a storage,
combining water from the 2nd decanter and a clear phase from the Ca(OH)₂ chemical treatment slow stirring reactor to obtain a second mixture, and sending the second mixture to an Al(OH)₃ treatment fast stirring reactor in a second chemical treatment process,
fresh preparation of Al(OH)₃ and storage in an Al(OH)₃ tank by using an Al₂ (SO₄)₃·18H₂O solution in a production of an adsorbent to be used in order to provide effective adsorption and a NaOH solution to bring the adsorbent to an active form, wherein the adsorbent is the Al(OH)₃,
performing a mixing process of the second mixture with the Al(OH)₃ in the Al(OH)₃ treatment fast stirring reactor and then continuing the mixing process in an Al(OH)₃ treatment slow stirring reactor to obtain a third sludge,
transferring the third sludge from the Al(OH)₃ treatment slow stirring reactor to a 3rd decanter and dewatering to obtain a solid,
sending a clear phase from the Al(OH)₃ treatment slow stirring reactor and a water phase from the 3rd decanter to the neutralization pond to obtain treated water,
sending the treated water to the neutralization pond before discharge,
reducing below a discharge standard value using a sulfuric acid (H₂SO₄) solution stored in an H₂SO₄ tank,
transferring the solid from the 3rd decanter to a desorption reactor to obtain a fourth sludge,
exposing the solid to a desorption process in an acidic environment using the H₂SO₄ solution, wherein the H₂SO₄ solution is an acidic chemical substance creating desorption conditions and removing boron compounds from a surface of the adsorbent to allow reuse of the adsorbent in the desorption reactor,
sending the fourth sludge from the desorption tank to the 1st decanter to obtain a fifth sludge,
sending the fifth sludge from the 1st decanter, after washing with effluent, to the Al(OH)₃ tank for reuse as the fifth sludge contains the Al(OH)₃,
sending water with a high boron content from the 1st decanter to a head of a plant.
